(19) United States
(12) Patent Application Publication
(10) Pub. No.: US 2010/0071681 A1
(43) Pub. Date: Mar. 25, 2010

(54) APPARATUS FOR CUTTING A STONE WHILE IN THE GROUND AND METHOD FOR MANUFACTURE

(76) Inventor: Darrell Robert Bade, Williams, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/237,951

(22) Filed: Sep. 25, 2008

(51) Int. Cl. B28D 1/08; B28D 1/04

(52) U.S. Cl. 125/21; 125/15

(57) ABSTRACT

Embodiments of stone cutting apparatus may include at least one sheave, which is coupled to a stone cutting belt to drivingly engage the stone cutting belt. Belt may include an endless cable, numerous abrasive segments disposed along the length of the cable, and a flexible belt body encapsulating the cable, and extending into the abrasive segments and between the abrasive segments. The abrasive segments may include a diamond top portion, a metal bottom portion, a first side, a second side, a first end and a second end. At least one bore in each abrasive segment, extending from the first and through the second end, is adapted to house the cable. The perimeter of the bore may be formed by the top diamond portion, the metal bottom portion and the interface between the diamond and metal portions of the abrasive segment. In another embodiment, each abrasive segment may further include a cutting portion and a mounting portion. The cutting portion faces a stone to be cut, and may project above the main belt body. The mounting portion is located opposite the cutting portion, and has a top, a middle, and a tongue. The tongue is made of metal and generally V-shaped. The tongue is adapted to extend into an outer circumference of the sheave, thus allowing the sheave to drivingly engage the abrasive segment. Methods of manufacturing a stone cutting belt are also disclosed.

### BACKGROUND

The present disclosure relates to stone cutting devices in general, and in particular to stone cutting devices useful for cutting stones which are in the ground, having a flexible and continuous stone cutting belt, and methods for making such stone cutting devices.

Composite tools, such as those containing a polycrystalline diamond active part allowing for mechanical removal of a hard material, are employed for cutting stones from quarries, drilling rocks in the mining or oil fields, extracting coal or other natural materials, and machining metals.

Stone cutting devices often contain a compacted composite abrasive as a cutting surface. Compacted composite abrasives generally are made by bonding an abrasive segment to a cemented carbide, such as a tungsten carbide. The cemented carbide then acts as a support for the abrasive strip or segment. The abrasive segment contains a mass of abrasive particles, typically diamond of cubic boron nitride, bonded into a hard conglomerate. This segment is generally polycrystalline in nature and contains a high abrasive particle content. Diamond compacts are also known as polycrystalline diamond (PCD). Cubic boron nitride compacts are also known as polycrystalline cubic boron nitride (PCBN).

Compacted composite abrasives are generally manufactured under elevated temperature and pressure conditions. They are used in a variety of cutting, drilling, milling and other operations. It is an edge or point formed on the abrasive segment of compacted abrasive compacts that performs the desired work. Compacted composite abrasives are commonly employed in the stone cutting and other industries, as noted above. Various means have been developed over the year for cutting stones and other hard materials, once they have been removed from the ground.

U.S. Pat. No. 5,749,775 to Fish describes a diamond belt for cutting stones after they have been removed from the ground. The belt also has continuous cables extend along the entire length of the belt and through bores the drive blocks; a main body made from a resilient material; and rigid segments. The rigid segments and cables are embedded in the main body in an injection molding process. The rigid segments have diamond surfaces, which project slightly above the body of the belt.

Various means have been developed over the years for cutting and removing hard natural stone from quarries. For example, U.S. Pat. No. 5,305,730 to Fish describes a stone cutting belt including a flexible and continuous main body. The belt has a plurality of cutting segments. Each of the cutting segments has a drive block and carrier block mounted on top of the drive block. The carrier block includes a tooth slot in which a cutting tooth is mounted, such as by silver soldering. Continuous cables extend along the entire length of the belt and through bores the drive blocks. The main body is made from a resilient material in which the cutter segments and cables are embedded in an injection molding process.

Tools for grinding of optical components may employ abrasive elements. For example, U.S. Pat. No. 5,891,206 to Ellingson describes metal bonded abrasive tools having an annular rim of metal bonded superabrasive joined to a central core, which is made from a different meal that the rim. The tools are made in a single sintering step that yields a near net shape abrasive tool. U.S. Pat. No. 6,283,112 to Beglund describes a continuous saw member having a wire, a plurality of cutting members which are connected and supported on the wire. In a mounted condition, the cutting members are also connected to a rider for engaging a saw. The cutting elements are floatingly supported on the wire and are in functional engagement with the driver members.

Abrasive tools for precision grinding of ceramics and ceramic composites may employ abrasive elements. For example, U.S. Pat. No. 6,102,789 to Ramanath et al. describes a tools consisting of a wheel core attached to an abrasive rim of metal bonded abrasive segments. The abrasive segments and core are bonded to one another by means of a thermally stable bond.

U.S. Pat. No. 3,672,881 to Sowko describes a method for making powder composites. First, a powdered metal is pressed into contact with another (pre-formed, previously sintered) metal component and shaped. The hard metal component and the diamond segment are then hot pressed together, producing little change in size of the finished product.

An apparatus and method for forming a cost-effective, long-lasting, strong stone cutting device useful for cutting stones which are in the ground, having cutting is desirable.

### SUMMARY OF THE DISCLOSURE

The stone cutting apparatus according to the disclosure may be a stone cutting belt including a cable with its free ends joined together, resulting in an endless cable, numerous abrasive segments disposed along the length of the cable, and a belt body made of a flexible material which coats the cable and extends into the abrasive segments and between the abrasive segments. The abrasive segments may include a diamond top portion, a metal bottom portion, a first side, a second side, a first end and a second end. There is a bore in each abrasive segment for housing the cable. The bore may extend from the first end though the second end of each abrasive segment. The perimeter of the bore may be formed by the top diamond portion, the metal bottom portion and the interface between the diamond and metal portions of the abrasive segment.

In another embodiment of the stone cutting apparatus, the apparatus contains at least one sheave and a stone cutting belt. The sheave is coupled to the stone cutting belt to drivingly engage the stone cutting belt. The stone cutting belt includes a cable with its free ends joined together, resulting in an endless cable, numerous abrasive segments disposed along the length of the cable, and a belt body made of a flexible material which coats the cable and extends into the abrasive segments and between the abrasive segments. The abrasive segments having at least one bore through which the cable may extend. Each abrasive segment further includes a a cutting portion and a mounting portion. The cutting portion faces a stone to be cut, and may project above the main belt body. The mounting portion is located opposite the cutting portion. It is at least partially covered by the flexible material that forms the main belt body and has a top, a middle, and a tongue. The tongue is made of metal and generally V-shaped. The tongue is adapted to extend into an outer circumference of the sheave, thus allowing the sheave to drivingly engage the abrasive segment.

A method of manufacturing a stone cutting belt is also disclosed. It includes the steps of: (1) blending a first metal powder and diamond particles together to form a mixture, and cold pressing this mixture to form a cutting segment having a flat top portion and an arched bottom portion; (2) mixing a second metal powder and cold pressing this mixture to form a mounting segment having a bottom portion and an arched top portion; (3) placing the cutting segment in a mold and positioning the mounting segment in the mold adjacent the cutting segment such that the arched bottom portion of the cutting segment is aligned with the arched top portion of the mounting segment; (4) hot pressing the cutting and mounting segments such that they meld together into a single abrasive unit having a bore with a perimeter corresponding to the arched bottom portion of the cutting segment and the arched top portion of the mounting segment, thus creating an abrasive unit; (5) placing a plurality of abrasive units on a cable by threading the cable through a bore in each abrasive unit; (6) tensioning the cable; and (7) encapsulating the cable and plurality of abrasive units in a flexible material to create a stone cutting belt.

### BRIEF DESCRIPTION OF THE DRAWINGS

FIG. 1 is a side view of the jib comprising a portion of a stone cutting device in the preferred embodiment of the present invention.

FIG. 2 is a fragmentary enlarged cross-sectional view of a portion of the jib shown in FIG. 1, taken along line 2-2 in FIG. 1 and viewed in the direction of the arrows.

FIG. 3 is a top view of the belt engaged on the jib shown in FIG. 1, taken along line 3-3 in FIG. 1.

FIG. 4 is a side view of the cutting belt of FIG. 3.

FIG. 5 is a side cross-sectional view of an abrasive segment comprising a portion of the belt, taken along line 5-5 in FIG. 4.

FIG. 6 is a side cross-sectional view of an alternate abrasive segment comprising a portion of the belt, taken along line 6-6 in FIG. 4.

FIG. 7 is a side cross-sectional view of the main body of a portion of the belt, taken along line 7-7 in FIG. 4.

### DESCRIPTION OF THE PREFERRED EMBODIMENTS

For the purposes of promoting an understanding of the principles of the disclosure, reference will now be made to the embodiment illustrated in the drawings and specific language will be used to describe the same. It will nevertheless be understood that no limitation of the scope of the claims is thereby intended, such alterations and further modifications in the illustrated device, and such further applications of the principles of the disclosure as illustrated therein being contemplated as would normally occur to one skilled in the art to which the disclosure relates.

This disclosure relates to highly abrasive stone cutting apparatus and belts, and methods for making them. Highly abrasive belts may be used for cutting stones, like marble, or granite, and so on. The apparatus and method disclosed aim at providing a strong, relatively inexpensive belt with increased longevity, capable of having cut accuracy even at high speeds, allowing for high productivity.

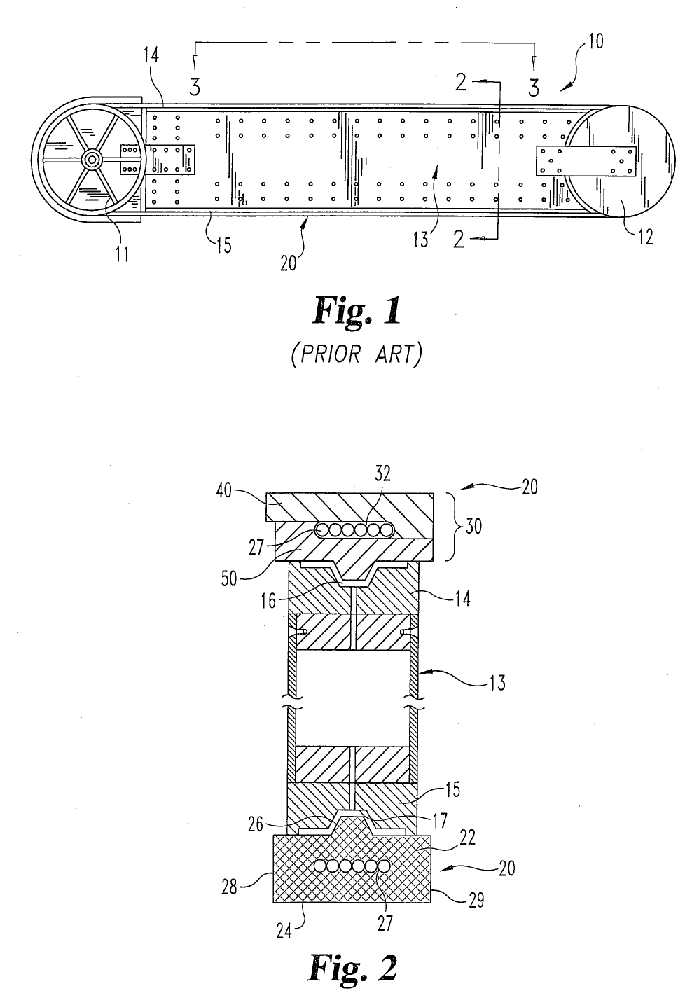

The preferred embodiments presently disclosed are devices for cutting a slot in stone located in the ground, as is described in U.S. Pat. No. 4,679,541. As seen in FIG. 1, the vehicle includes a jib 10, pivotally mounted to the mainframe of the vehicle. The jib 10 includes a pair of sheaves 11 and 12 mounted to the opposite ends of the jib. A jib frame 13 supports the sheaves 11 and 12 at opposite ends of the frame. Typically, sheave 11 will be situated above ground and will be driven by suitable means mounted in the vehicle. The jib frame 13 includes groove members 14 and 15 mounted to the top and bottom edges of the frame in a conventional manner. A belt 20 extends in a continuous fashion around sheaves 11 and 12 and immediately adjacent and in contact with groove members 14 and 15. Jib frame 13 further includes grooves 16 and 17, which are mounted to the bottom of the frame in a conventional manner and integral with groove members 14 and 15.

The belt 20 is a continuous flexible belt which extends around and is in driven engagement by the aligned sheaves 11 and 12. The belt 20 includes a continuous flexible main body 22 which is produced from polyurethane or other suitable plastic or flexible material. The main body 22 of belt 20 further includes a top surface 24, a bottom end 26, and flat sides 28 and 29. Top surface 24 is generally flat. Flat sides 28 and 29 are perpendicular to top surface 24. The bottom end 26 of the belt main body 22 is configured as a truncated V-shaped projection extending complementarily into the outer circumference of each of the sheaves 11 and 12, thereby enabling sheave 12 to drivingly engage the belt. The bottom end 26 extends from the bottom surface of the belt 20 along the length of the belt. The bottom end 26 extends into grooves 16 and 17 of the jib frame 13. End 26 engages the complementary-shaped outer circumferences of sheaves 11 and 12 so that the belt 20 can be driven by the rotation of the sheave 11. While the bottom end 26 is depicted in the truncated V-shape, it is understood that other configurations, such a non-truncated V-shape, a U-shape, a W-shape, a T-shape and so forth would work equally, so long as the outer circumference of sheaves 11 and 12 and grooves 16 and 17 were complementarily shaped to accommodate such alternate configurations. Alternatively, it is also contemplated that outer circumference of sheaves 11 and 12 and grooves 16 and 17, rather than being complementarily shaped, could be such that they engaged grooves 16 and 17 and sheaves 11 and 12 in a hook and clasp manner or as male and female counterparts for only a portion of their configuration.

The main body 22 of the belt 20 further includes a wire cable 27 which extends parallel to flat sides 28 and 29 through the length of the belt main body 22 to increase the strength thereof. As shown in FIG. 7, the cable 27 is arranged in a plurality of rows which extend at least partially across the width of the belt main body. In the preferred embodiment, the belt includes a single cable which extends multiple times around the length of the belt thereby forming the multiple rows. Alternatively, a plurality of wire cables may be arranged in side-by-side fashion with each cable extending through the length of the belt. The cables 27 are shown as being made of wire, such as aircraft cable. Each of the cables 27 is continuous throughout the length of the belt 20 to provide increased strength to the belt 20. This is generally accomplished by joining each free end of the cables with its other free end in a suitable manner. Alternatively, the free ends of cables could be joined to other free ends of adjacent cables, thereby producing a single, continuous cable formed from several cables. The cables 27 may have a uniform shape and cross-section, for example that of a circle. There may be instances where irregularities in the cables 27 are preferred, for example, an increased radius of cable may be desired for a certain portion of the cable. Also contemplated within this disclosure are: cables that are non-continuous, provided the belt has necessary strength to function; cables with a cross-section that is not circular, such as triangular, square, polygonal, or otherwise regularly or irregularly shaped. The cables 27 are generally made from metal, but may also be made of a suitable plastic, nylon, or other material, so long as the necessary strength is imparted.

On this flexible main body 22 there are provided abrasive segments 30. Abrasive segments 30 contain a bore 32, through which cable 27 may be threaded, thereby connecting rigid segments 30 to main body 22 of the belt 20. The cable 27 is not actually itself affixed to abrasive segment 30, but rather is positioned within the bore 32 of abrasive segment 30. The abrasive segments 30 may be regularly spaced and connected both to each other and to the cable 27, by the flexible main body 22, which fills both the bores 32 of the rigid segments 30 and intervals between the individual rigid segments 30. Bore 32 is sufficiently large to allow the cable 27 to extend through the bore 32 without contacting either of the walls of the abrasive segment 30. Flexible main body 22 may surround the cable 27, thereby insulating it from the bore walls. Isolating the cable 27 from the walls of the bore 32 of abrasive segment 30 may prevent wear on the cable that might otherwise occur as the belt flexes while traveling around the sheaves 11 and 12.

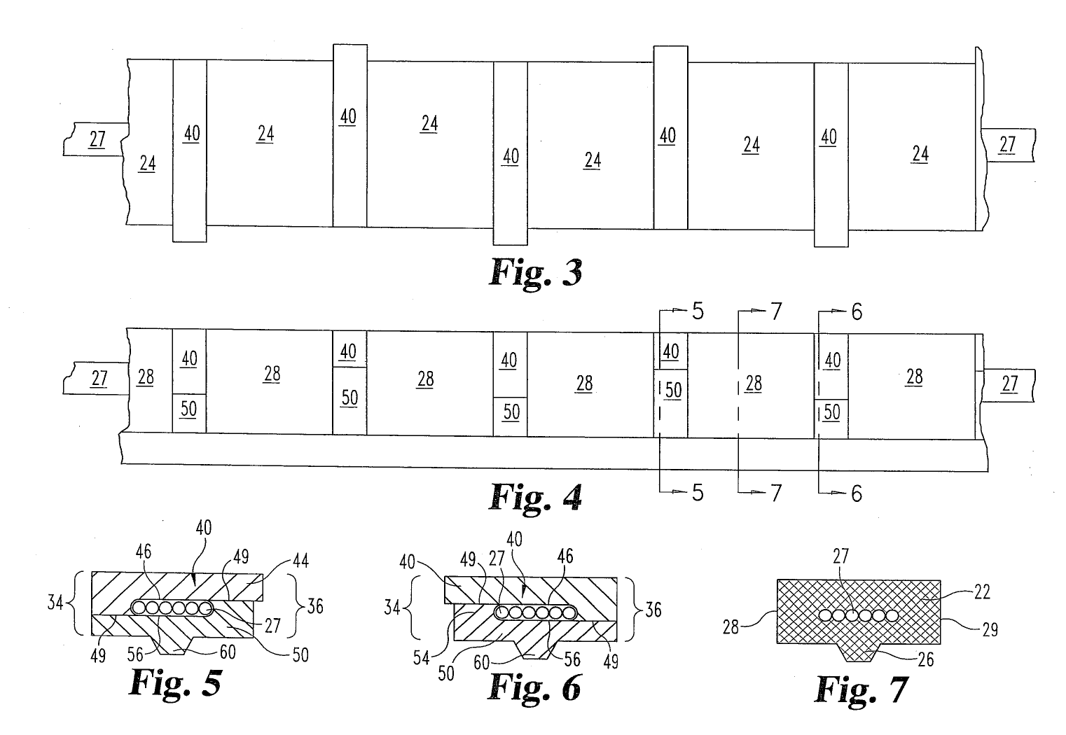

Abrasive segment 30 is further composed of diamond top portion, or cutting portion, 40 and a metal bottom portion, or mounting portion, 50. Abrasive segment 30 also has two equal sides, 34 and 36, which may be composed of either cutting portion 40, mounting portion 50 or a combination of portions 40 and 50. The abrasive segments 30 occur at regular intervals, along main body 22. As seen in FIG. 3, main body 22 (specifically top surface 24 of main body 22 in this illustration) occupies the intervals between abrasive segments 30. Generally, the interval between abrasive segments is significantly more than the space occupied by the segment 30. In one embodiment, the interval between abrasive segments is 3 inches. It is contemplated that there might be uses for which having a substantially smaller interval between abrasive segments 30 would be useful. It is also contemplated that there may be uses where a larger interval between abrasive segments 30 is needed. These variations are firmly within the boundaries of this disclosure.

The cutting portion 40 further includes an overhang 42, a leg 44, a bottom surface 46 and upper surface 48. The cutting portion 40 generally includes a large number of small hard particles (e.g. diamonds or other suitably hard cutting agent) held together by a substrate or filler, generally a softer metal. The hard particles are capable of performing an abrasive function and may be distributed throughout, either uniformly or non-uniformly, the cutting portion. Suitable hard particles include carbons, e.g., diamonds (i.e., natural synthetic and polycrystalline diamonds); nitrides (i.e., cubic boron nitride); carbides, and borides. At least some of the hard particles may be in the form of agglomerates of the individual hard particles. The cutting segment generally consists of a hard particles present in an amount of 70 percent, and, more often, 80 to 90 percent, by volume of the cutting portion, though there may be applications where lower volumes, such as 60, 50 or 40 percent may be-useful. In a particular embodiment, bronze is used as the filler and diamonds (size of U.S. 16-20 mesh) are positioned uniformly throughout.

Mounting portion 50 further includes a leg 54, a top surface 56, and a middle 58, and a tongue 60. The cutting portion 40 and mounting portion 50 intersect at an interface 49. The mounting segments 50 are made of metal. In one embodiment, the mounting segments 50 is made of a cemented carbide such as cemented tungsten carbide, cemented tantalum carbide, cemented titanium carbide or a mixture thereof.

In one embodiment of the present disclosure (as seen from the top view of belt in FIG. 3), the cutting portion 40 of the abrasive segment 30 extends slightly beyond flat side 28 or flat side 29 of main body 22. This overhang 42 of cutting portion 40 may enable, and more specifically the staggered arrangement of overhang 42 of cutting portion 40 may help eliminate vibration or chatter of the belt during the stone cutting operation. In some embodiments (as shown in FIG. 3), the overhang 42 may alternate sides between abrasive segments—that is, overhang 42 may extend beyond flat side 28 on one abrasive segment, beyond flat side 29 on the next abrasive segment, and so on. It is also contemplated that abrasive segments 30 may have the overhangs 42 which all extend beyond only one flat side (e.g. 28 only) of belt, that the overhangs may alternate in a different manner (e.g. two abrasive segment having the overhang 42 beyond flat side 28, then two having the overhang 42 beyond flat side 29); and may alternate in a predictable or unpredictable manner.

As seen in FIG. 4, the height of abrasive segments 30 are co-extensive with main body 22—that is flat side 28 of main body is has the same vertical measurement as the segment 30 when considered from a side view, as the top of each abrasive segment 30 is flush with the top surface 24 of main body 22.

In one embodiment (FIG. 5), cutting portion 40 has a downwardly turned L-shape. A leg 44 of that L configuration comprises most, if not all of side 34. As depicted, in this embodiment, side 34 is composed of cutting portion. The side 36, in this embodiment, is composed of a portion of cutting portion 40 and a portion of mounting portion 50. In this embodiment, overhang 42 of cutting portion 40 is always opposite leg 44. Bore 32 of abrasive segment 30 is formed by the intersection (and gap between) a bottom surface 46 of cutting portion 40 and a top surface 56 of mounting portion 50. Although depicted as a single bore 32, it is within this disclosure for there to be a plurality of bores within segment 30 formed by the interfaces and gaps between cutting portion 40 and mounting portion 50.

In another embodiment (FIG. 6), cutting portion 40 has a backwards and downwardly turned L-shape. A leg 44 of that L configuration comprises most, if not all of side 36. As depicted, in this embodiment, side 36 is composed of cutting portion 40. The side 34, in this embodiment, is composed of a portion of cutting portion 40 and a portion of mounting portion 50. In this embodiment, overhang 42 of cutting portion 40 is always opposite leg 44. Bore 32 of abrasive segment 30 is formed by the intersection (and gap between) a bottom surface 46 of cutting portion 40 and a top surface 56 of mounting portion 50. Although depicted as a single bore 32, it is within this disclosure for there to be a plurality of bores within segment 30 formed by the interfaces and gaps between cutting portion 40 and mounting portion 50.

As shown in FIGS. 5-6, the cutting portion 40 of abrasive segments 30 is generally some variation of an L-shape. The leg 44 can have various lengths, according to what is desirable in configuring the cutting portion 40. It is contemplated that the cutting portion 40 could be differently configured; for example, the cutting portion 40 could be shaped like a downwardly facing C, having two legs, rather than a single leg. The cutting portion 40 could have no legs, and therefore be more I shaped.

In one embodiment (FIG. 5), mounting portion 50 has an upwardly turned L-shape. A leg 54 of that L configuration comprises most of side 36 of the abrasive segment 30. As depicted, in this embodiment, side 36 is composed predominantly of mounting portion 50. The side 34, in this embodiment, is composed of a portion of cutting portion 40 and a portion of mounting portion 50. Bore 32 of abrasive segment 30 is formed by the intersection (and gap between) a bottom surface 46 of cutting portion 40 and a top surface 56 of mounting portion 50. Although depicted as a single bore 32, it is within this disclosure for there to be a plurality of bores within segment 30 formed by the interfaces and gaps between cutting portion 40 and mounting portion 50.

In an alternate embodiment (FIG. 6), mounting portion 50 has an upwardly turned backwards L-shape. A leg 54 of that L configuration comprises most of side 34. As depicted, in this embodiment, side 34 is composed mostly of mounting portion. The side 36, in this embodiment, is composed of a portion of cutting portion 40 and a portion (to a lesser extent) of mounting portion 50. Bore 32 of abrasive segment 30 is formed by the intersection (and gap between) a bottom surface 46 of cutting portion 40 and a top surface 56 of mounting portion 50. Although depicted as a single bore 32, it is within this disclosure for there to be a plurality of bores within segment 30 formed by the interfaces and gaps between cutting portion 40 and mounting portion 50.

In both FIGS. 5 and 6, the tongue, or bottom portion, 60 of the mounting portion 50 is depicted as a truncated V. In one embodiment of the present disclosure, tongue 60 is made from metal. Tongue 60 may be integral with mounting portion 50 or mounting portion 50 and tongue 60 may be made separately and later joined together. In some embodiments, tongue 60 may be made from plastic or other flexible material and attached to mounting portion 50. It is thought that when the tongue 60 is made from plastic, if may result in differential wear between the middle 58 and top surface 56 (which are made of metal) of mounting portion 50 and tongue 60, possibly resulting in a weak spot where tongue 60 is affixed to the rest of the mounting portion 50. When tongue is formed from a plastic or other material that is less rigid and long-wearing than metal, the tongue 60 of mounting portion 50 may also wear more quickly than the rest of mounting portion 50, thus needing maintenance or replacement when the rest of mounting portion 50 is not in need of such servicing.

As shown in FIGS. 5-6, the mounting portion 50 of abrasive segments 30 is generally some variation of an L-shape. The leg 54 can have various lengths, according to what is desirable in configuring the mounting portion 50. It is contemplated that the mounting portion 50 could be differently configured; for example, the mounting portion 50 could be shaped like a upwardly facing C, having two legs, rather than a single leg. The mounting portion 50 could have no legs, and therefore be more I shaped. The cutting portion 40 is generally on the top portion of segment 30 and mounting portion 50 is generally on the bottom portion of segment 30. Bore 32 is generally formed by a gap created when cutting portion 40 and mounting portion 50 do not extend far enough to meet. Bore is additionally formed by the interface 49 between cutting portion 40 and mounting portion 50. Alternative designs for cutting portion 40 and mounting portion 50 which preserve the creation of bore 32 at the interface 49 and by a gap between the bottom surface 46 and the top surface 56 are within this disclosure. Bore 32 is generally shown as being oval, and thus bottom surface 46 and top surface 56 are generally arc-shaped where they form bore. Bore 32 could also be generally rectangular, square, circular, or otherwise regularly or irregularly shaped. As such, bottom surface 46 and top surface 56 could also be differently shaped to accommodate the formation of a bore with any of these general shapes.

FIG. 7 shows the main body 22 of belt 20, with the top surface 24, the bottom end 26, the flat side 28, and the flat side 29. Also shown is cable 27 running through the center of main body 22. Cable 27 is not housed in a bore within main body 22, as will be more fully explained below with reference to the manufacturing of the belt 20.

Methods of manufacturing stone cutting belts as disclosed above will now be explained. Formation of the abrasive segment will first be discussed. The abrasive segment 30 may be formed by bonding a cutting segment to a mounting segment. The method involves the creation of two components: (1) a cutting component and (2) a mounting component. These two components are placed in a mold and hot pressed to form an abrasive rim which can be burred and sand-blasted before being primed for final form.

The cutting component is made by mixing diamond (or an alternate hard, cutting substance) powder with a metal powder. This mixture is then cold pressed (for example at approximately 80 to 200 kN) to an exact weight and approximate size. The mounting component is made from a metal powder or a mixture of metal powders that is also cold pressed to an exact weight and approximate size. The size of the mounting segment is selected so that it matches the cutting segment. Obviously, depending on the desired final shape and distribution between the cutting segment 40 and mounting segment 50, a mounting component which “matches” the cutting component may have a variety of shapes and sizes. The cold pressed cutting component and the cold pressed mounting component are placed in a mold, such as a carbon mold, adjacent one another. When placing the cutting component and mounting component alignment of the two may be considered, such that the bore 32 will be formed when final abrasive segment 30 is finished. The mold, cutting component and mounting component are placed under high heat and high pressure and hot pressed to form abrasive segment 30. Hot pressing may be done at a temperature of about 500 degrees to 700 degree C. under a pressure of about 15 MPa to 48 MPa. More specifically, hot pressing may occur at 570 degree to 650 degree C. under 32 to 48 MPa of pressure for 6 to 10 minutes. As is known in the art, the temperature may be ramped up (e.g., from 25 degree to 570 degree C. for 6 minutes; held at 570 degree C. for 9 minutes) or increased gradually prior to applying pressure to the mold contents.

Following hot pressing, the graphite mold is stripped from the abrasive segment 30, it is cooled and is finished by conventional techniques to the desired dimensions and tolerances. It may be burred and sandblasted to a final form. It may be primed such that plastic (e.g. the material which forms main body 22 of belt 20) will adhere to it.

In making each abrasive segment 30, every component (e.g. cutting, mounting and tongue components) has gone through exactly one cold pressing and hot pressing process. The formation of the abrasive segment 30 occurs in a single hot press process, as the cutting component and mounting component are cold pressed only before being hot pressed into the abrasive segment 30. As a result of the pre-formation of all components to an exact weight and rough size prior to hot pressing, when the abrasive segment 30 is removed from its mold less material removal is needed to put the abrasive segment 30 into its final shape. This reduces the number of steps needed to finish the abrasive segment 30 prior to placing it on the belt 20.

When making the mounting segment 50, the tongue 60 may be made as part of the cold pressed mounting component. If the tongue 60 is part of mounting component, then the cold pressing of mounting component will include the formation of the tongue 60. Likewise, when mounting component and cutting component are brought together to undergo hot pressing, the mold used for hot pressing will be shaped to accommodate the truncated-V shaped tongue 60. In this manner, the tongue 60 may be made from the same metal as the rest of mounting segment 50. Alternatively, tongue 60 may be made of metal, but not made as an integral piece of mounting component. If the tongue 60 is made a separate component, it may be made from a metal powder or a mixture of metal powders and then cold pressed to an exact weight and approximate size. It may then be hot pressed in the same mold with the cutting and mounting components. It may also be hot pressed separately, and later soldered, brazed or otherwise attached to mounting segment 50. In yet another embodiment, the tongue 60 may be made from plastic and suitably attached to mounting segment 50 prior to formation of the main body 22 of the belt 20.

This method of manufacture of abrasive segment 30 does not require brazing or soldering, and therefore, may result in a stronger bond. The method is also less expensive than other methods, such as brazing, and may aid in the prevention of disproportionate shrinkage when the mount and diamond segment are joined. Further benefits includes: (1) the powder for the cutting component may be handled less allowing for better hard substance (e.g. diamond) distribution in the cutting portion; (2) the separate cold pressing of each component of abrasive segment 30 allows for a diamond free mounting segment 50 and a hard-substance laden cutting segment 40; (3) in the formation of cutting segment 40, hot pressing occurs only once, causing minimal thermal damage to the hard substance (e.g. diamonds); (4) hot pressing of the cold pressed cutting component with the cold pressed mounting component in one step may produce a abrasive segment with a continuous microstructure at the interfaces 49, partially be allowing the grains in the base metals of each component to grow together as the abrasive segment 30 solidifies when hot pressed. In the case of two previously hot pressed components then being hot pressed together, there is likely to be a distinct delineation in the grain structure at the junction of the two halves. (5) There is a reduced time involvement in making the abrasive segment 30 using the cold pressing method than there would be if either cutting component or mounting component were hot pressed as loose powder (e.g. not cold pressed prior to being hot pressed). In order to hot press loose powder, each component must be weighed individually by hand and hand loaded into a mold. When using the method where components are individually cold pressed, and then hot pressed, the cold pressing of components may be automated, thus allowing for greater speed and repeatability.

Additionally, the above method of formation of the abrasive segments 30 also has advantages for the belt 20 during use and during the maintenance of the belt: (1) the abrasive segment 30 is stronger since the cutting portion 40 and the mounting portion 50 are one piece. Any braze or solder joint is eliminated, which eliminates the possibility of failure along this joint. (2) Repair of the belt can be performed without the risk of weakening a braze or solder joint. To repair the belt the plastic must be burned off the belt. While the temperature used to do this is below the braze or solder melting temperature, there is a possibility that the joint could be weakened by the heat. Since this joint is eliminated, repairing the belt does not have the possibility of weakening the joint.

Manufacture of the main body 22 of belt 20 will now be described. Abrasive segments 30 may be “threaded” onto the cable, through the bore 32. If a single cable 27 is used, the cable may be looped repeated through the bore 32 in abrasive segment 30. Alternatively, multiple cables may be used or, if the cable 32 has sufficient strength, it may only go through the bore 32 in abrasive segment 30 once. The cable 27 is tensioned (for example at approximately 1,000 pounds), and then the cable 27 may be coated with a primer, thus allowing the plastic of main body 22 to adhere to the cable 27. The cable 27, the abrasive segments 30, (in their desired arrangement) are placed in an injection mold with the mold. The abrasive segment 30 may be positioned in the injection mold so that the upper surface 48 of the cutting portion 40 of abrasive segment 30 is flush with the top surface 24 of the main body 22 of the belt 20. Likewise, additional surfaces of abrasive segment 30 (e.g. sides 34 and 36, as well as tongue 60 of mounting portion 50) may also be placed in the injection mold such that they will be flush with additional surfaces of main body 22 (e.g. the top surface 24, the bottom end 26, and flat sides 28 and 29) when belt 20 is formed.

The mold may be at approximately 150° F. when the abrasive segments 30 and cables 27 are positioned in the mold. Polyurethane (or another material used for main body 22) is then injected into the mold to encapsulate the cutter segments 19 and the continuous cables 30. During the injection molding process, the polyurethane may infiltrate the bores 27 in abrasive segment 30, surrounding the cables 27 and securely anchoring abrasive segment 30 to the cables 27. The encapsulated belt 20 may then be cured at approximately 280° F. In this manner, the abrasive segments 30 and the cable 27 may be embedded in main body 22. Main body 22 of belt 20 may extend throughout the entire length of the belt 20 and may be used to position the plurality of abrasive segments 30 along the length of the belt 20.

In an alternate embodiment, abrasive segments 30 may be made in a manner that does not involve melting of the base metals in the cutting portion or mounting portion, such as by brazing or soldering. In this embodiment, both cutting portion 40 and mounting portion 50 would be hot pressed separately. After each of the portions 40 and 50 are formed, then the portions are suitably affixed to one another. For example, cutting portion may be anchored to the mounting portion by a pair of hollow dowel pins which are silver soldered to each cutting portion. In this alternate embodiment, the bore 32 may be located entirely within the mounting portion or near the interface between cutting portion and mounting portion. Because filler metals are used in this embodiment to join together the cutting and mounting portions, the interface 49 between cutting and mounting portions is non-existent in these embodiments. Additionally, in this embodiment, the tongue 60 of mounting segment 50 may be made of metal and an integral part of mounting segment 50 (and thus formed as the rest of mounting segment 50 is formed), or the tongue 60 may be a separate piece which is attached in a suitable manner after mounting segment 50 has been formed. If the tongue 60 is a separate piece, it may be made from metal, plastic, or other suitable materials.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

I claim:

1. A stone cutting belt comprising:
at least one cable having a length and two free ends, said free ends being joined together to form an endless cable;
a plurality of abrasive segments, said segments including a diamond top portion, a metal bottom portion, a first side, a second side, a first end, a second end, and a bore adapted to house said cable, said bore having a perimeter and extending longitudinally from said first end to said second end;
said plurality of abrasive segments being disposed along the length of said cable and forming intervals between said segments;
a flexible material forming the main belt body and extending into said bore of said abrasive segments and said intervals, said flexible material connecting said segments to each other and to said cable; and
wherein said perimeter of said bore is formed by said top diamond portion, said metal bottom portion and an interface between said diamond portion and said metal portion of said abrasive segment.

2. The belt of claim 1, wherein said diamond top portion extends to and includes a portion of said first side of said abrasive segment.

3. The belt of claim 2, wherein said diamond top portion extends to and includes all of said first side of said abrasive segment.

4. The belt of claim 3, wherein said metal bottom portion extends to and includes a portion of said second side of said abrasive segment.

5. The belt of claim 4, wherein said metal bottom portion extends to and includes all of said second side of said abrasive segment.

6. The belt of claim 5, further comprising said metal bottom portion of said abrasive segment having a tongue located opposite said interface between said diamond portion and said metal portion.

7. The belt of claim 6, wherein said tongue is generally in the shape of a V.

8. The belt of claim 7, wherein said abrasive segment contains only one bore.

9. The belt of claim 8, wherein said diamond top portion extends longitudinally beyond said second side.

10. The belt of claim 9, wherein said interface comprises materials from each of said lower surface of said cutting portion and materials from said upper surface of said mounting portion.

11. The belt of claim 10, wherein said cutting portion is a polycrystalline diamond.

12. A stone cutting apparatus comprising:
at least one sheave in driven engagement with a stone cutting belt;
said stone cutting belt comprising:
at least one cable having a length and two free ends, said free ends being joined together to form an endless cable;
a plurality of abrasive segments having at least one bore through which said cable may extend, said plurality of abrasive segments being disposed along the length of said cable and forming intervals between said segments;
a flexible material forming the main belt body and extending into said bore of said abrasive segments and said intervals, said flexible material connecting said segments to one another and said segments to said cable; and
said segments further comprising a cutting portion and a mounting portion, said cutting portion projecting above said main belt body and facing a stone to be cut;
said mounting portion located opposite said cutting portion, and being at least partially covered by said flexible material that forms said main belt body, said mounting portion having a top, a middle, and a tongue, said tongue being made of metal and generally V-shaped; and
wherein said tongue is adapted to extend into an outer circumference of said sheave, allowing sheave to drivingly engage said abrasive segment.

13. The stone cutting apparatus of claim 12, wherein said middle and said tongue of said mounting portion are a single, integral piece.

14. The stone cutting apparatus of claim 13, wherein said top, said middle and said tongue of said mounting portion are a single, integral piece.

15. The stone cutting apparatus of claim 14, wherein said outer circumference of said sheave has a complementary shape to said generally V-shaped tongue.

16. A method of manufacturing a stone cutting belt comprising the steps of:
a) blending a first metal powder and diamond particles together to form a mixture, and cold pressing said mixture to form a cutting segment having a flat top portion and an arched bottom portion;
b) mixing a second metal powder and cold pressing said mixture to form a mounting segment having a bottom portion and an arched top portion;
c) placing said cutting segment in a mold and positioning said mounting segment in the mold adjacent said cutting segment such that the arched bottom portion of said cutting segment is aligned with the arched top portion of said mounting segment
d) hot pressing said cutting and mounting segments such that they meld together into a single abrasive unit having a bore with a perimeter corresponding to said arched bottom portion of said cutting segment and said arched top portion of said mounting segment creating an abrasive unit;
e) placing a plurality of said abrasive units on a cable by threading said cable through said bore in each of said abrasive units;
f) tensioning said cable;
g) encapsulating said cable and plurality of abrasive units in a flexible material to create a stone cutting belt.

17. The method of manufacturing a belt of claim 16, wherein said cutting segment extends to and includes a portion of a first side of said abrasive unit.

18. The method of manufacturing a belt of claim 17, wherein said cutting segment extends to and includes all of said first side of said abrasive unit.

19. The method of manufacturing a belt of claim 18, wherein said bottom portion of said mounting segment extends to and includes a portion of a second side of said abrasive unit.

20. The method of manufacturing the belt of claim 19, wherein said bottom portion of said mounting segment of said abrasive unit is generally tongue-shaped.
